(19) United States
(12) Patent Application Publication
(10) Pub. No.: US 2003/0186679 A1
(43) Pub. Date: Oct. 2, 2003

(54) Methods, apparatus and program product for monitoring network security

(75) Inventors: David Carroll Challener, Raleigh, NC (US); David Robert Stafford, Brewster, NY (US); Leendert Peter Van Doorn, Valhalla, NY (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/107,794

(22) Filed: Mar. 27, 2002

(51) Int. Cl. H04M 1/68

(52) U.S. Cl. 455/410; 455/411; 380/247

(57) ABSTRACT

Methods, apparatus and program products which monitor access points through which data can be exchanged with a network, identify an unauthorized access point, and determine the location of the identified unauthorized access point.

### BACKGROUND OF THE INVENTION

The 802.11 standard is a family of specifications created by the Institute of Electrical and Electronics Engineers Inc. for wireless local area networks in the 2.4-gigahertz bandwidth space. 802.11 can be thought of as a way to connect computers and other gadgets to each other and to the Internet at very high speed without any cumbersome wiring—basically, a faster version of how a cordless phone links to its base station. With 802.11, electronic devices can talk to each other over distances of about 300 feet at 11 megabits a second, which is faster than some wired networks in corporate offices.

Devices using 802.11—increasingly known as Wi-Fi—are relatively inexpensive. A network hub, also known as an access point, can be bought for about $500 and will coordinate the communication of all 802.11 equipped devices within range and provide a link to the Internet and/or any intranet to which the access point is linked. The cards that let a laptop computer or other device “plug” into the network cost $100 to $200. Some personal communication devices come enabled for 802.11 communications without the need of an additional card. Wireless 802.11 cards and access points are flying off the shelves of computer suppliers. People want and find easy connectivity with 802.11-standard products. Such networks are also know by more formal names as ad-hoc wireless networks and, in some instances, as mobile ad-hoc networks or MANETs.

Providing so much wireless speed at a modest price is having profound implications for a world bent on anytime/anywhere communication. Wi-Fi is spreading like kudzu. College students are setting up networks in their dorms and cafeterias. Folks in some parts of San Francisco are building 802.11 networks to cover their neighborhoods. Starbucks Corp., United Airlines Inc., and Holiday Inn, among others, are installing 802.11 networks in their shops, airport lounges, and hotels, in a nod toward their customers' desire to stay connected. It has been reported that, in 2000, the number of people using wireless local area networks rose by 150 percent, according to Synergy Research Group. Cahners In-Stat Group, a Scottsdale, Ariz.-based market research firm, sees the number of wireless data users in business growing from 6.6 million today to more than 39 million by 2006. Feeding this trend is the fact that almost a quarter of all workers in small or medium-sized business are mobile workers, spending at least 20 percent of their time away from the office. Wireless e-mail is their prime need, which is why mobile computing products with always-on e-mail capability continue to sell so well. In early 2002, it was estimated that between 25,000 and 50,000 people install and manage 802.11 networks every day.

The wireless trend will inevitably spill over into the home networking market. A major reason is price: The cost of access points, equipment that connects to the wireless network; and network interface cards, or NICs, that make the link between the PC and the access point, is dropping. Those low prices catch the eye of shoppers, which is why the home market grew 20 percent in the last quarter of 2001.

Successor technologies to 802.11 are on the horizon. One is ultra-wide band radio technology or UWB, which uses a wide spectrum at low power to transfer data at a very high speed. UWB will be perhaps ten times faster than 802.11, yet suffer for some of the same exposures described here. Another is the inclusion of radio frequency function directly on chips which perform other functions such as system central processors.

And there's the rub, and a real dilemma it presents. Once again, information technology administrators and users are caught between ease of use and requirements for security. There are two major problems with wireless today and which can be anticipated as remaining into the future. One is that all too often it is implemented without any kind of security at all. The other is that the out-of-the-box security options, if the consumer switches them on, are completely ineffectual. According to Gartner Dataquest, about thirty percent of all companies with a computer network have some kind of wireless network, either official or rogue. Furthermore, if the business or cafe next door has a wireless network, the business might be in trouble.

Wireless is so wide open, in fact, that it has given birth to a new technologist Olympic sport: war driving. The game is all about seeing how many potential targets can be found. All that is needed to play is a laptop, a wireless PC card, and some software. War driving has been widely discussed in the technical press and on technologist web sites, and does occur on a regular basis. The new hobby for bored teenagers and technogeeks is to drive around with an antenna and GPS strapped to a laptop hunting for wireless access points. While most are not maliciously attacking networks and are carefully preventing themselves from accessing the network and any of the files contained therein, not everyone is so polite.

One of the more popular tools used in war driving, NetStumbler, tells you the access point name, whether encryption is enabled, and numerous other bits of information. NetStumbler is also a great tool for administrators trying to identify rogue, unauthorized, access points which have been connected in their organizations. One user picked up twenty access points during a quick drive down Highway 101 in Silicon Valley. Another user, cruising the financial district in London and using an antenna made from an empty Pringles brand potato chip can found almost sixty access points in thirty minutes. Kismet is a wireless network sniffer for Linux that includes many of the same capabilities as NetStumbler. AirSnort is a Linux-based tool that tries to recover encryption keys. These and many more tools are freely available on the Internet.

Although organizations still must be vigilant about securing their main Internet gateway, the corporate perimeter is expanding wirelessly. How many users access the internal network via a VPN or other means of remote access? How many of those users have wireless networks at home? Are they secure? If not, your internal network is vulnerable, regardless of how secure your main Internet gateway is. Until 802.11 and UWB are made and proven secure, smart network managers will keep worrying. Particularly where employees lacking authorization to do so go to their friendly computer supply store, buy a wireless hub, bring it to their place of employment, and power it up connected to their employer's intranet.

### SUMMARY OF THE INVENTION

The present invention has as a purpose enabling a network administrator or manager to identify the presence of a rogue, or unauthorized, access point, thereby assisting in enhanced security for networks. A further purpose is to enable determination of the location of an unauthorized access point.

These purposes are pursued by methods, apparatus and program products which monitor access points through which data can be exchanged with a network, identify an unauthorized access point, and determine the location of the identified unauthorized access point.

### BRIEF DESCRIPTION OF THE DRAWINGS

Some of the purposes of the invention having been stated, others will appear as the description proceeds, when taken in connection with the accompanying drawings, in which:

FIG. 1 is a schematic representation of a network installed within a facility, including workstation computer systems and a server computer system, and to which an unauthorized access point has been attached;

FIG. 2 is a simplified flow chart showing steps performed in the workstations forming a portion of the network of FIG. 1;

FIG. 3 is a simplified flow chart showing steps performed in the server system forming another portion of the network of FIG. 1;

FIG. 4 is a view of a computer readable medium bearing a program effective when executing on an appropriate one of the systems of FIG. 1 to implement the steps of the respective one of FIGS. 2 and 3.

### DESCRIPTION OF THE PREFERRED EMBODIMENT(s)

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

As briefly mentioned above, a problem with the proliferation of the 802.11 standard is that it is easily possible for a person to set up a wireless access point to a network, without the information technology (IT) organization responsible for managing the network knowing about it. This is a problem because such access points may be (and usually are) misconfigured, thus granting to the world access to the network and data residing therein.

When such access points are put up, there is no way to determine by querying the network that they are there or how they are configured. Current solutions are to use Net Stumbler (or similar software) on a mobile computing device such as a notebook or personal digital assistant (PDA), use signal strength measurements to determine when the user is getting closer to or further away from an access point, and make manual reference to an index to determine if the access point is an unauthorized “rogue”. This requires a person to periodically sweep through a facility to find any unauthorized access point.

This invention provides a way to locate unauthorized access points quickly, without the necessity of having a wandering user.

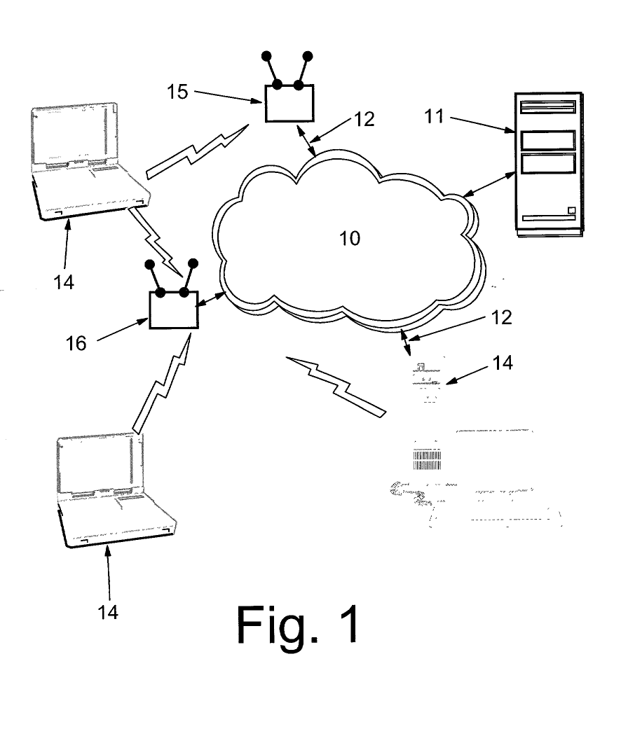

Referring now more particularly to the Figures, FIG. 1 illustrates a network 10 having a server computer system 11, a plurality of authorized access points 12 which may be either wireless or wired, and a plurality of workstation computer systems 14. Each workstation computer system 14 is coupled to the network, either through a wireless connection or possibly through a wired connection. Depending upon the size and scope of a facility, managed networks may have a mix of types of systems and types of connections. The workstations may be notebook computer systems, personal digital assistant systems, advanced function telephones, desktop or minitower systems, or other devices capable of accessing the network 10 through the access points.

Access to the network 10 may come through an authorized wireless access point 15 and, in the illustrated network, through an unauthorized or rogue wireless access point 16. The rogue access point 16 may have been established by an individual or group acting without the knowledge or permission of the information technology management. In accordance with some purposes of this invention, the detection and location of the rogue access point 16 is a goal to be accomplished.

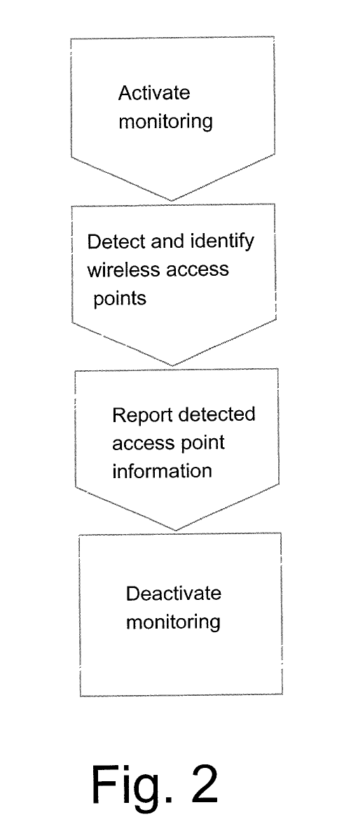

In accordance with the present invention, at least one, if not a plurality or even all, of the workstations 14 is equipped with a facility for wireless or radio frequency connection to the network 10. This or these workstations also have monitoring software installed, such as Net Stumbler, which is capable of detecting and gathering information about all wireless access points with which the system can communicate. In addition, and in accordance with this invention, the system(s) also has/have reporting software installed which is capable of passing the information gathered by the monitoring program back into the network 10 and to the server computer system 11. FIG. 2 represents schematically the functions of the software installed on a workstation 14.

Where it is desired that a minimal number of monitoring and reporting systems are used, the number may be reduced to what is known mathematically as a dense set. That is, a set of systems close enough to all points where a rogue access point might be located that at least one system will detect the rogue. For a small building or area, a single system may provide the dense set. For larger areas, a plurality of systems as shown in FIG. 1 are more desirable.

The present invention contemplates that the information gathered about access points detected by a workstation will include information about signal strength. The present invention also contemplates that the monitoring software may be executed periodically as distinguished from continuously. Thus, the software might be executed once an hour or once a day during normal business hours so as to avoid imposing an excessive burden on other uses of the workstations. Executing the monitoring software may require temporarily setting the network interface card (NIC) or wireless interface into a different mode to gather information, then resetting the interface so that normal operation continues. This can be done quickly enough so as to be outside the awareness of most if not all users. Monitoring may also include an initial check of the activity of the access points sensed, in order that signal strength measurements can be appropriately calibrated.

Using a single workstation to monitor will provide two data points: whether there is a rogue access point and the signal strength of the rogue access point. Discussion will follow later in this description of the potential advantages of using multiple monitoring stations.

As monitoring occurs and information is gathered, the information is reported through the network to the server 11. The information transmitted may be encrypted or otherwise sheltered against inappropriate access. The server system has software installed which receives the reported information, maintains a list of authorized access points, and compares the reported information to the list. The server system thereby identifies any rogue or unauthorized access point, such as the point 16 in FIG. 1, which has come within communications reach of one of the monitoring workstations. The server system also stores information about the reported signal strength.

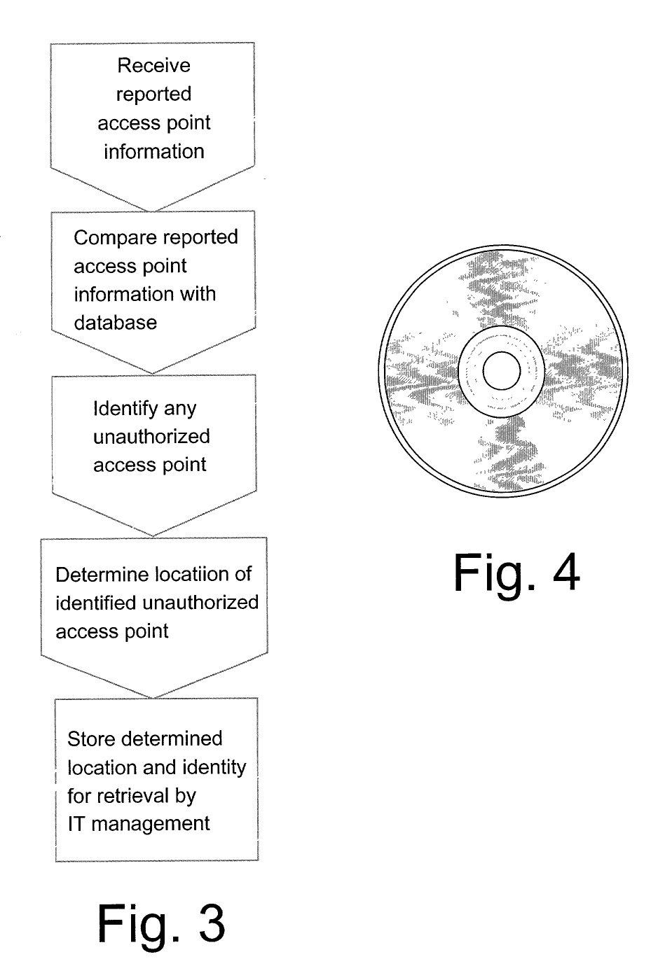

The responsible IT organization will know the location of each workstation 14 or be able to determine that location (should be workstation be mobile) by analysis of the signal strengths of the reported access points such as the points 15 and 16 in FIG. 1. From this information, and the reported signal strengths of the detection of a rogue access point, the location of a rogue access point can be determined. FIG. 3 represents schematically the functions of the software installed on the server system 11.

The present invention contemplates that the operations described may be enhanced by such activities as providing wireless access points distributed through an area to be monitored and which are specifically not connected to the network. Such dummy access points will provide additional information about relative signal strengths and may assist in locating points which have been positioned somewhat remotely from authorized access points. Additionally, monitoring stations which are inactive as workstations may likewise be distributed through an area to be monitored specifically for the purpose of monitoring areas which may be somewhat remote from the usual distribution of fixed or mobile workstations. Information may be selectively gathered about monitoring stations as well as access points, providing additional data points for analysis. Such information about other clients may be monitored and reported, and the server system may use such information to locate —or not locate—monitoring systems as well as rogue and authorized access points.

With the workstations and server system cooperating, the present invention implements a method in which monitoring access points through which data can be exchanged with a network occurs, an unauthorized access point is identified, and the location of the identified unauthorized access point is determined. This follows from equipping each of a plurality of computer devices to detect access points accessible to the device and to report to a server computer system the identity of detected access points. Monitoring comprises intermittently and periodically determining the availability of access points, which can be intermittently and periodically determining the availability of access points by monitoring at predetermined regular intervals or at random irregular intervals. Identification an unauthorized access point is done by comparing the identity of monitored access points with a database of authorized access points. Determining the location of an identified unauthorized access point is done by comparing the locations of a plurality of computer devices all of which report detection of the identified unauthorized access point.

Software appropriate to the functions described here may be distributed to users using computer readable media such as the diskette shown in FIG. 4, which may bear software which, when executing on either a workstation system or a server system, causes the system to perform the sequences shown in FIGS. 2 and 3, as appropriate to the type of system onto which the software is installed.

In the drawings and specifications there has been set forth a preferred embodiment of the invention and, although specific terms are used, the description thus given uses terminology in a generic and descriptive sense only and not for purposes of limitation.

What is claimed is:

1. A method comprising the steps of:
monitoring access points through which data can be exchanged with a network,
identifying an unauthorized access point, and
determining the location of the identified unauthorized access point.

2. A method according to claim 1 wherein the step of monitoring comprises equipping each of a plurality of computer devices to detect access points accessible to the device and to report to a server computer system the identity of detected access points.

3. A method according to claim 1 wherein the step of monitoring comprises intermittently and periodically determining the availability of access points.

4. A method according to claim 3 wherein the step of intermittently and periodically determining the availability of access points comprises monitoring at predetermined regular intervals.

5. A method according to claim 3 wherein the step of intermittently and periodically determining the availability of access points comprises monitoring at random irregular intervals.

6. A method according to claim 1 wherein the step of identifying an unauthorized access point comprises comparing the identity of monitored access points with a database of authorized access points.

7. A method according to claim 1 wherein the step of determining the location of an identified unauthorized access point comprises comparing the locations of a plurality of computer devices all of which report detection of the identified unauthorized access point.

8. A method comprising the steps of:
monitoring with a suitably equipped computer device access points through which data can be exchanged with a network and gathering information about a monitored access point,
reporting through the network to a server computer system the information gathered by monitoring, and
identifying an unauthorized access point by operation of the server system.

9. A method according to claim 8 wherein the step of monitoring comprises equipping each of a plurality of computer devices to detect access points accessible to the device and to report to the server computer system the identity of detected access points.

10. A method according to claim 8 wherein the step of monitoring comprises intermittently and periodically determining the availability of access points.

11. A method according to claim 10 wherein the step of intermittently and periodically determining the availability of access points comprises monitoring at predetermined regular intervals.

12. A method according to claim 10 wherein the step of intermittently and periodically determining the availability of access points comprises monitoring at random irregular intervals.

13. A method according to claim 8 wherein the step of identifying an unauthorized access point comprises comparing the identity of monitored access points with a database of authorized access points.

14. A method according to claim 8 further comprising determining the location of an identified unauthorized access point by comparing the locations of a plurality of computer devices all of which report detection of the identified unauthorized access point.

15. A method comprising the steps of:
equipping each of a plurality of computer devices to detect access points accessible to the device through which data can be exchanged with a network and to report to a server computer system the identity of detected access points;
comparing the identity of reported access points with a list of authorized access points and identifying an unauthorized access point; and
comparing the locations of a plurality of computer devices all of which report detection of an identified unauthorized access point.

16. A method according to claim 15 wherein the step of equipping computer devices comprises providing each computer devices with a wireless local area network connection device.

17. A method according to claim 16 further comprising the steps of reporting the signal strength at which each computer device links with each detected access point and analyzing the relative signal strengths of pairs of authorized and unauthorized access points to determine access point locations.

18. Apparatus comprising:
a workstation computer system;
a network interface connected to said system and providing a communication channel between said system and a network;
an access point identification program stored accessibly to said system and cooperating therewith when executing on said system to identify points accessible through said interface; and
a reporting program stored accessibly to said system and cooperating with said identification program and with said system when executing on said system to report through said interface to a remote server computer system the identity of accessed points.

19. Apparatus according to claim 18 wherein said network interface comprises a wireless connection capability.

20. Apparatus according to claim 18 wherein said workstation computer system is a mobile computing device.

21. Apparatus according to claim 20 wherein said mobile computing device is a notebook computer system.

22. Apparatus according to claim 18 wherein said workstation computer system is a desktop computing device.

23. Apparatus comprising:
a server computer system,
a network interface connected to said system and providing a communication channel between said system and a network,
an access point identification program stored accessibly to said system and cooperating therewith when executing to identify nodes accessible through said interface, and
a node identification database stored accessibly to said system and said program and cooperating therewith when said program is executing on said system to identify unauthorized access points accessible to said system through said interface.

24. Apparatus according to claim 23 further comprising an access point location program stored accessibly to said system and cooperating therewith when executing to identify the location of any unauthorized access point accessible through said interface.

25. A program product comprising:
a computer readable medium; and
a program stored on said medium accessibly to a computer system, said program when executing on a system:
monitoring access points through which data can be exchanged with a network,
identifying an unauthorized access point, and
determining the location of the identified unauthorized access point.

26. A program product comprising:
a computer readable medium; and
a program stored on said medium accessibly to a computer system, said program when executing on a system:
monitoring access points through which data can be exchanged with a network,
identifying an access point, and
reporting to a remote server computer system the identified access point.
